(19) United States
(12) Patent Application Publication
(10) Pub. No.: US 2017/0145673 A1
(43) Pub. Date: May 25, 2017

(54) Cats eye restricted actuator with a bihemispherical seal actuating a plunger guided by a removable threaded basket guide.

(71) Applicant: Christopher Adam McLeod, Toronto (CA)

(72) Inventor: Christopher Adam McLeod, Toronto (CA)

(21) Appl. No.: 14/946,758

(22) Filed: Nov. 19, 2015

(51) Int. Cl. E03C 1/23; F16K 31/46

(52) U.S. Cl. CPC E03C 1/2302; F16K 31/46

(57) ABSTRACT

A remotely actuated drain is provided by a bihemispherically sealed rod actuator restricted by a cat's eye restrictor to move in a vertical direction. This rod in turn actuates a plunger to move vertically to open the drain, the vertical motion of the plunger ensured by a central tubular guide up which the plunger stalk rod travels. The central guide is supported in the center of the drain by a threaded basket threaded into an internal thread provided in the top portion of the drain body to provide a removable anchor for the central guide. This cat's eye restricted actuator with a bihemispherical seal actuating a plunger guided by a removable threaded basket guide can be sized and fitted to a variety of vessels, including lavatory sinks, baths, and utility sinks.

### FIELD OF THE INVENTION

This Invention relates generally to sealed actuators, and more particularly to providing mechanically actuated opening in drainage outlets of lavatory sinks and baths.

### BACKGROUND OF THE INVENTION

The challenge of providing watertight actuation of a drain closure plunger within a drainage outlet has given rise to a number of sealing designs for actuators of drain closure. Since corners lead to leakage, one of the most successful of these designs is the bihemispherical seal, wherein a solid plastic sphere transfixed by an actuating rod is captured by two annular hard plastic bushings. Each said annular bushing incorporates a concave seat complementary to the radius of the sphere on one side of said annular bushing and incorporates a flat on the opposing side of said annular bushing. Said actuator rod penetrates the central hole of each bushing to allow the annular bushings to mount onto opposing sides of the sphere surface. The two bushings fitted to the solid sphere in this way comprise an actuating assembly. Said actuating assembly is then mounted into a tube with a terminal annular rim stop concentric to the longitudinal axis of the tube and formed into the one end of said tube to prevent egress of said actuating assembly out one end of the tube while allowing egress of the actuating rod which is free to rotate within the confines of the hole in the terminal annular rim stop. The opposite end of the tube is decorated with an external thread to receive a tightening basket nut perforated by a central hole concentric to the nut circumference, again to allow egress of the actuating rod. A basket nut is equivalent to an internally threaded cap with a hole in the center of the top, leaving a circular rim perpendicular to the longitudinal axis of the nut that can exert a packing pressure on the flat side of the proximal annular hard plastic bushing. This allows a mechanism by which the packing can be adjusted to optimize tightening for sealing for liquid leakage against ease of rotation of the sphere. Actuation is effected by manipulation of the end of the rod distal to the drain body in turn initiating an equal and opposite motion of the end of the rod protruding within the drain body.

The entire assembly comprising the threaded and rim-stopped tube, the two bushings, the sphere pierced by the rod, and the tightening basket nut can be called a bihemispherically sealed rod actuator, and can be mounted perpendicularly to a flanged drain using a plurality of methods to provide a watertight rod actuator for actuation of a drain closure plunger. Said flanged drain hangs by its flange from a drainage hole provided in a vessel such as a lavatory sink, the end distal to the flange connected to further drainage fittings. Washers and a nut threaded onto the external pipe thread after the flanged pipe has been passed through the drainage hole in the bottom of the sink cinch the flange tightly to vessel inner surface. Said drainage closure plunger comprises a vertical portion fitting within the drainage outlet pipe, a means of support for the vertical portion to rise and lower concentric to the drainage pipe, a device for capturing the end of the actuator rod to enable remote actuation, and, a top plunger head including one of a plurality of sealing gaskets that make a seal in the lowered, closed position of the plunger between said head and the upper surface of the flange on the flanged drainage outlet pipe with which the vessel is equipped. Vessels that can be fitted with this kind of closure include a lavatory defined as a hand washing vessel and also known as a lavatory sink or sink, and a bath defined as an immersion bathing device, also known as a tub.

The challenges to existing remotely actuated vessel drain closures actuated by a bihemispherically sealed rod actuator include smooth actuation of the plunger, consistently vertical rise of the plunger when opened, and access for cleaning. Christiansen (U.S. Pat. No. 3,353,192: Nov. 29, 1964) employs a precursor to the bihemispherically sealed rod actuator that lifts a perforated tube within the drainage pipe to allow for drainage. The lower end of said perforated tube is equipped with a hole accepting and capturing the proximal end of the actuating rod to form a linkage preventing the plunger from being withdrawn from the vessel interior for cleaning. Said linkage is accomplished at the time of installation of the drain to the lavatory sink. Regarding smooth actuation, the narrow space between the outer wall of the perforated tube and the inner wall of the drainage pipe accumulates biofilm and metal oxides, requiring extra force for actuation. Regarding cleaning, even if the linkage between the actuator rod and the plunger stalk has a device whereby the plunger stalk can be released from the actuator rod, that is not visually obvious to the cleaner of the lavatory sink, who may perceive there are no means by which the plunger can be removed for cleaning of the tube exterior. Politz (U.S. Pat. No. 3,453,667: Jul. 8, 1969) improved upon Christiansen by providing a plunger comprising a sealing head supporting a vertical stalk equipped with radial fins whose width approximated that of the internal diameter of the drainage pipe. While this lessens the potential for friction between the plunger and the interior wall of drainage pipe, verticality of the plunger throw is compromised, resulting in the upmost sealing head of the plunger looking off-center or cock-eyed when viewed in the open position from the lavatory sink. Lavatory sink drains are usually open, so a drain closure cock-eyed in the open position is an aesthetic problem. Regarding cleaning, although Politz provides a device by which the plunger may be removed for cleaning, it is not obvious to the user how to disconnect the plunger from the actuating rod mechanism. Wentz (U.S. Pat. No. 4,380,834: Apr. 26, 1983) reverts to Christiansen's tubular plunger and also provides a mechanism for disengaging the plunger from the actuating rod. Regarding cleaning, this mechanism is not intuitive to the user of the lavatory sink wishing to clean it. Lavatory sink drains collect hair and not having an intuitive means by which to remove the plunger and clean it presents a challenge to the lavatory sink user. Further, some designs require regular cleaning to smoothly actuate, accentuating the need for an obvious method of retracting, removing, and cleaning the plunger.

### SUMMARY OF THE INVENTION

Accordingly, it is an objection of this invention to at least partially overcome some of the disadvantages of the prior art.

The Invention is a bihemispherically sealed rod actuator such as described above, with key differences. These differences are the inclusion of a cat's eye restriction on the inner, outer, or both sides of the bihemispherically sealed sphere such that the actuator rod can only move in a vertical direction. A cat's eye restrictor is defined as a vertical slot inscribed into or adjacent to a spherical surface. The vertical slot in this case is inscribed in the inner wall of the vertical pipe portion of the drain fitting, and said slot is sized horizontally to allow passage of the diameter of the actuator rod, and vertically to the limits of the rod motion within the actuator. The spherical surface in this case is the concave seat in the adjacent annular bushing. The replacement of the regularly encountered circular perforation of the drain fitting pipe with said cat's eye restrictor allows the actuator to simply push the bottom of a plunger up when actuated remotely to the interior of the pipe such that the rod points up within the drainage pipe, and exerts an upward force on a plurality of plunger devices to open the drain, without any horizontal motion of the rod. Restriction of actuator motion to vertical allows for a slim rod to hit a small target on the bottom of the plunger when actuating. Closure is achieved by raising the end of the actuator rod distal to the drain outlet, and allowing the plunger to fall by gravity.

The plunger will fall by gravity smoothly if there is limited friction between the plunger and the inner wall of the drainage outlet pipe, and if the relative movement of the plunger within the drainage outlet pipe is such that the longitudinal axis of the plunger is always collinear with the longitudinal axis of the drainage outlet pipe. In this Invention, the plunger is reduced to a single rod of small diameter relative to the internal diameter of the drainage outlet pipe in which it travels. Vertical travel throughout is ensured by a central guide comprising a tube slightly larger in internal diameter than the outer diameter of the rod, said guide being of sufficient height relative to the rod diameter such that vertical travel is ensured, in a piston-like device. Said vertical tubular guide for the rod is suspended in the concentric center of the drain outlet pipe by a plurality of horizontal arms, said arms themselves hanging from an equal number of vertical supports attached to an upmost ring. Said ring is equipped with an external threaded ring that threads into the internal thread cut into an upper portion of the internal wall of the drain fitting pipe. This combination of threaded ring suspending vertical supports from which hang horizontal arms that support the central guide for the plunger is called the threaded basket. Said threaded basket can also perform the function of hair catcher, either alone or in concert with a removable device. Accordingly, when the user of the sink notices drainage is poor, or as a regular maintenance task, pulls on the plunger head, it removes and the threaded basket can also be removed for cleaning. Because the central guide ensures a vertical stroke of the plunger, the cat's eye restriction on the bihemispherically sealed actuator ensures that the actuating rod hits the target of the bottom of the plunger stem and does not deviate to the side, frustrating the actuation. The problem of an off-center plunger head in the open position is also resolved.

The cat's eye restricted actuator with a bihemispherical seal actuating a plunger guided by a removable threaded basket guide can also be implemented as a part of a remotely actuated drain closure system in a bath drain outlet. Remote actuation of the actuator rod can be achieved by a plurality of means.

### BRIEF DESCRIPTION OF THE DRAWINGS

In the drawings, which illustrate embodiments of the invention:

FIG. 1 shows an isometric view of the cat's eye actuator mounted into a drain fitted into a lavatory sink;

FIG. 2(a) shows a lateral exploded view of bihemispherically sealed actuator, drain body, and plunger, and (b) shows a detail of a cutaway to show the internal mounting thread for the threaded basket;

FIG. 3(a) shows a top view of the cat's eye drain, (b) a vertical section of the drain, and (c) a detail view showing the cat's eye restrictor slot;

FIG. 4 (a) shows a lateral view of the remotely actuated lavatory drain, (b) shows a horizontal cross-section showing the threaded basket supporting a central guide for the plunger stalk;

FIG. 5 shows a cutaway of a lateral view of the actuator contacting the plunger, showing thread ring and central guide for the plunger stalk;

FIG. 6 (a) shows an isometric view of the threaded basket.

To assist in the understanding of one embodiment of the present Invention, the following list of components and associated number found in the drawings is provided herein:

| Component Number | Component Name |
|---|---|
| 1 | Lavatory sink vessel |
| 3 | Vessel interior |
| 5 | Plunger head |
| 7 | Drain outlet flange |
| 9 | Actuator rod |
| 11 | Actuator mount |
| 13 | Drain |
| 15 | Drain outlet |
| 17 | Plunger seal |
| 19 | Plunger stalk |
| 21 | Plunger stalk height adjuster |
| 23 | Drain body |
| 25 | Overflow perforation |
| 27 | Underside seal |
| 29 | Slip washer |
| 31 | Seal nut |
| 33 | Tailpiece thread |
| 35 | Tailpiece |
| 37 | Actuator mount adapter |
| 39 | Proximal annular bushing |
| 41 | Distal annular bushing |
| 43 | Actuator sphere |
| 45 | Basket nut |
| 47 | Central guide |
| 49 | Horizontal arm |
| 51 | Vertical support |
| 53 | Threaded ring |
| 55 | Cat's eye slot wall |
| 57 | Actuator track |
| 59 | Threaded basket |
| 61 | Contact of actuator with plunger |
| 63 | Cat's eye restrictor slot |
| 65 | Travel channel |
| 67 | Actuator mount external thread |
| 69 | Tailpiece thread hub |
| 71 | Internal mounting thread |
| 73 | Plunger |

### DETAILED DESCRIPTION OF THE INVENTION

The Invention described in this application is a novel drain fitting for vessels including lavatory sinks and baths. A restrictor added to a commonly used actuator assembly allows for vertical actuation of a plunger by contact and upward thrust, with the addition of a central guide for said plunger, said central guide supported by a threaded basket threaded into a thread-in drain body.

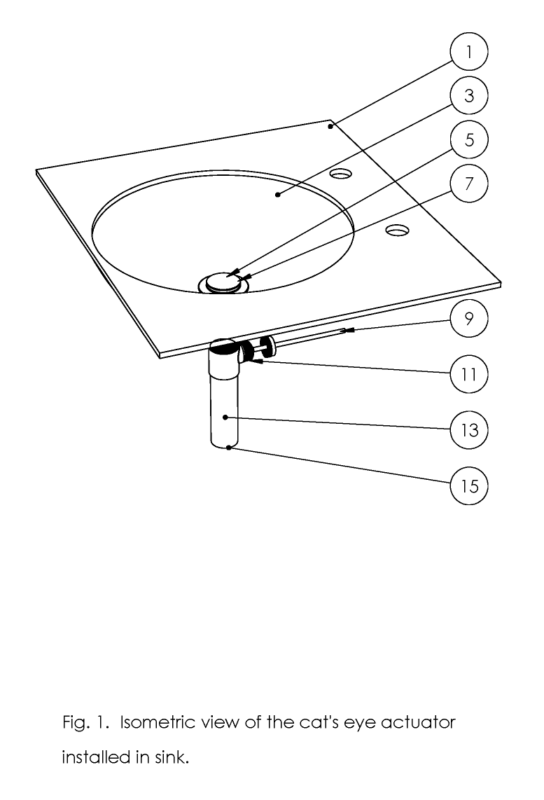

In FIG. 1, a lavatory or lavatory sink or sink or vessel is shown in isometric view as fitted with a drain 13 into the drainage hole found at the bottom of the vessel interior 7. Visible from above is a fixed drain outlet flange 7 and the head 5 of a moving plunger. If this plunger is connected to the underlying actuator assembly it cannot be removed for cleaning. If a device for disconnecting and reconnecting the plunger from the underlying mechanism is provided, it is hidden from the view of the user. The actuator rod 9 is mounted in a horizontal actuator assembly mount 11 in turn mounted to the lavatory drain 13 to control the outflow of water from the terminal lowermost distal drain outlet 15.

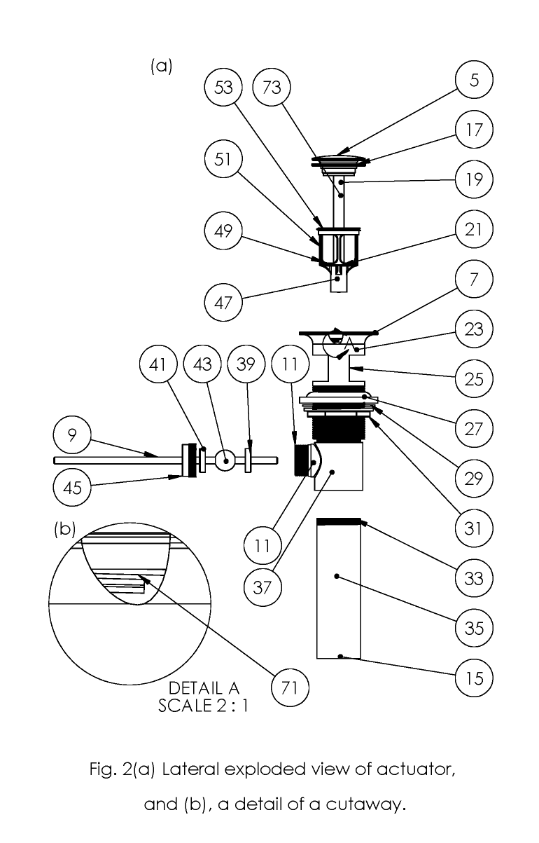

In FIG. 2(a) the lavatory drain is shown in an exploded view, showing, from the top, that the plunger head 5 supports a plunger seal 17 that seals against the drain outlet flange 7 when actuated to do so by means of a suspended plunger stalk 19 that passes through a central guide 47 supported by a plurality of horizontal support arms 49. Said horizontal support arms are suspended from a thread ring 53 by vertical supports 51. The threaded ring 53 of the threaded basket threads into an internal thread not visible in this diagram near the top of the drain body 23 to anchor the basket and the central guide to the drain body. Said internal thread is located above the optional overflow perforations 25 that provide for drainage from a vessel overflow often provided in the lavatory sink. The drain flange 7 hangs from a drainage hole in the lavatory sink in the bottom of the vessel interior 3 and is secured from movement by a Mack washer 27 tightened by a seal nut 31 enabled by an optional slip washer 29. The actuator mount 11 is attached horizontally to an actuator mount adapter 37 into the underside of which threads the tailpiece 35 thread 33. Into the actuator mount 11 is inserted the actuator rod 9 which has permanently pierced an actuator sphere 43 and is sandwiched by two opposing distal annular bushings, the proximal 39 and the distal 41. A basket nut 45 packs the bushings 39 and 41 against the actuator sphere 39 when tightened onto the distal external thread of the actuator mount 11. This provides both for seal against water leakage and allows movement of the actuator within the confines described by the perforation in the interior of the actuator mount adapter, as demonstrated in the next Figure. A cutaway of the drain outlet flange 7 is detailed in FIG. 2(b), wherein an internal mounting thread 71 is provided for the mounting of the threaded ring 53 to anchor the entire threaded basket 59. Although anchored, the threaded basket 59 can be removed by unthreading once the plunger 73 is removed. In order for the threaded basket 59 to be removable for cleaning or replacement, the plunger must therefore be removable simply by pulling on the plunger head 5.

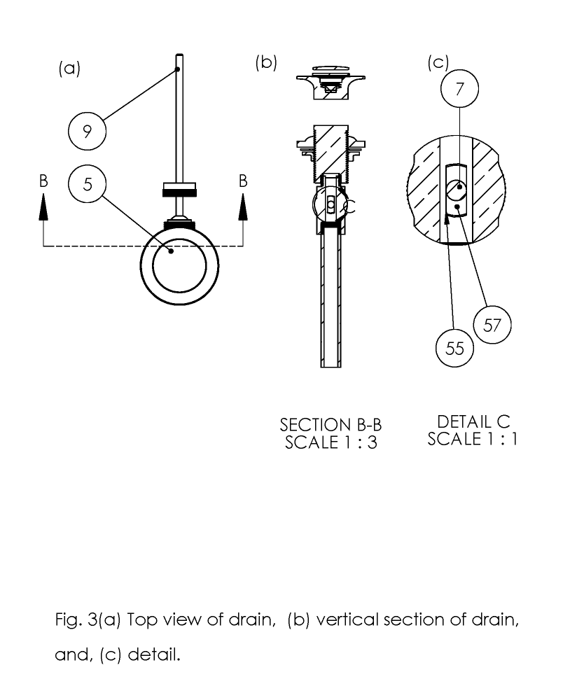

In FIG. 3(a) a top view of the cat's eye drain is shown with actuator rod 9 and plunger head 5. In FIG. 3(b) this view is sectioned vertically and FIG. 3(c) shows a detail of this cross section revealing the actuator track 57 defined by the cat's eye slot wall 55 that limits the travel of the actuator to a strictly vertical linear tracking.

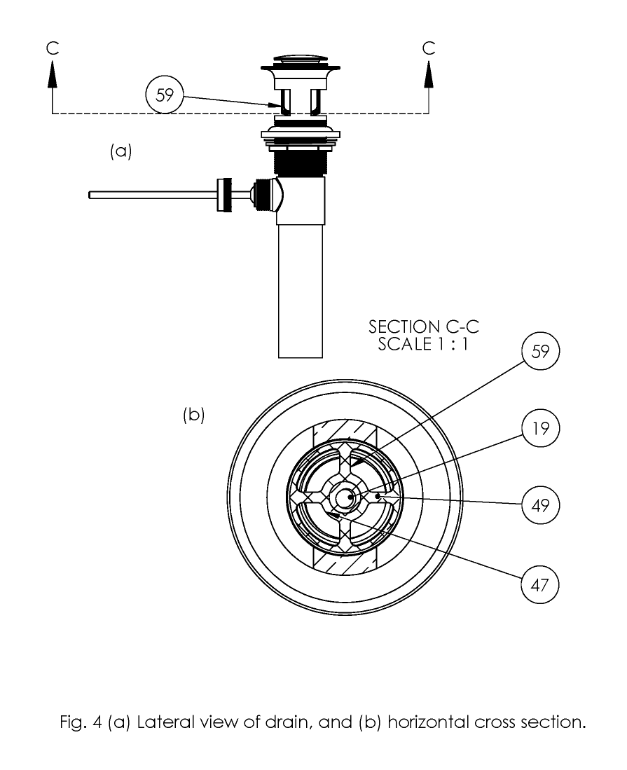

In FIG. 4(a) a lateral view of the drain showing the threaded basket 59 anchored in place is sectioned to reveal in FIG. 4(b) the threaded basket 59, and the horizontal arms 49 supporting the central guide 47 that in turn guides the plunger stalk 19 to move only in a vertical direction.

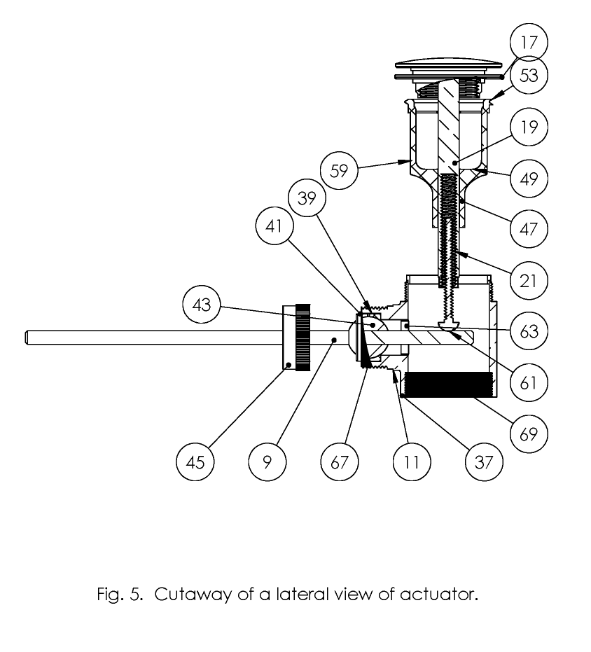

In FIG. 5 a lateral view of just the actuator portion of the lavatory drain is shown with a partial cutaway to demonstrate the thread ring 53, that, when threaded into the lavatory drain body interior, provides an anchor to the vertical supports 59 that support the horizontal arms 49 that keep the central guide 47 in the center of the interior space of the drain. Said central guide 47 guides a plunger stalk 19 to only move vertically. An optional plunger stalk height adjuster 21 is shown. Said adjuster 21 allows for optimization of plunger throw for a given actuation angle. The actuation of the distal end of rod 9 rotates the actuator sphere 41 sealed by being sandwiched by two annular bushings 39 and 41 tightened by a basket nut 45 threaded onto the terminal distal external thread 1 on the actuator mount 11. This allows rod movement while maintaining a water seal. The travel of the actuator rod 9 is limited to vertical travel by the cat's eye restrictor slot 63. When the end of the actuator rod 9 distal to the drain is pushed down by a plurality of means, the proximal end of the actuator rod 9 is thus pushed up via rotation of the actuator sphere 41. The internal threaded hub 69 on the actuator mount adapter 37 is provided for a tailpiece connection.

Since the actuator rod 9 can only move vertically owing to the cat's eye restrictor, the proximal end of the rod moves to contact the plunger stalk at 63, lifting the plunger vertically since the plunger stalk 19 is guided vertically by the central guide 47. This allows the plunger seal 17 to move upward away from the flange it was sealing against in the close position. When the distal end of the actuator rod is pulled up, the proximal end moves vertically down, and allows the plunger to descend by gravity in a vertical direction guided by the central guide in the threaded basket threaded into the drain body. At all times, the plunger can be removed by pulling on the plunger head on the inside of the lavatory sink, and the threaded basket unthreaded and removed for cleaning or replacement.

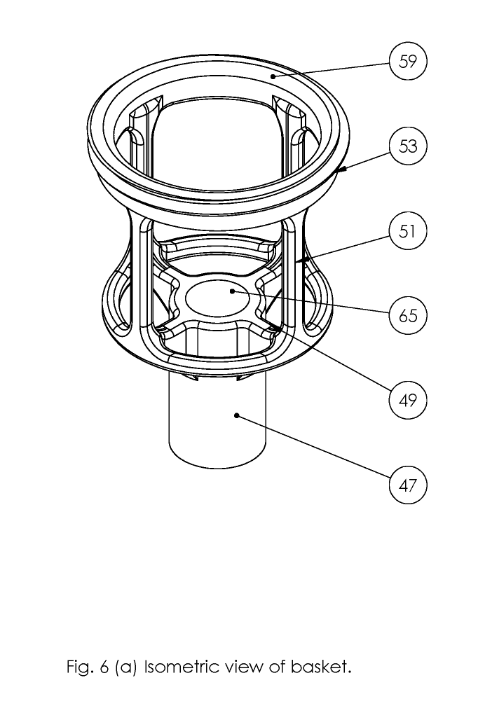

FIG. 6 shows an isometric view of the threaded basket 59, exhibiting the externally threaded ring 53 from which are suspended a plurality of vertical supports 51 that in turn support horizontal arms 49 that in turn place the central guide 47 concentric to the vertical axis of the drain body.

With appropriate sizing, the same cat's eye restricted actuator with a bihemispherical seal actuating a plunger guided by a removable threaded basket guide could be used in a larger drain such as a bath drain or utility sink drain. The rod can be actuated from a remote location by a plurality of means including cable drive, and adjustable lift and drop assembly, or electronic means.

1. A drain fitting comprising:
an actuator rod transfixing an actuator sphere sandwiched by two annular bushings
a horizontal actuator mount accommodating said rod, sphere and bushings and tightened by a basket nut.
an actuator mount adapter to which the actuator mount is horizontally attached.
a drain body comprising a flanged pipe with seals and nuts to affix it to a vessel body, and to the bottom of said body is attached the actuator mount adapter.
a tailpiece attachment fitted to the bottom of the actuator mount adapter for attachment to more drainage piping.

2. The drain fitting as claimed in claim 1 wherein a vertical slot perforation is provided in the interior of the roughly cylindrical wall of the actuator mount adapter, said slot having its center collinear with the horizontal axis of a tubular actuator mount affixed to the side of the actuator mount adapter, said slot having vertical sides spaced to allow actuator rod movement, and said slot having upper and lower boundaries that are coradial to the inner circumference of the tubular actuator mount.

3. A threaded basket is threaded into the upper interior of the drain body to anchor a central tubular guide concentrically to the vertical axis of the drain, said guide acting to restrict a plunger rod to move only vertically.
